(19) United States
(12) Patent Application Publication
(10) Pub. No.: US 2008/0250691 A1
(43) Pub. Date: Oct. 16, 2008

(54) FISHING POLE WITH STRIKE INDICATOR AND BROAD ILLUMINATION LIGHTING FEATURES

(76) Inventors: Jason L. Barnes, Phoenix, AZ (US); James T. White, Phoenix, AZ (US)

Correspondence Address: MICHAEL WINFIELD GOLTRY, 4000 N. CENTRAL AVENUE, SUITE 1220, PHOENIX, AZ, 85012, US

(21) Appl. No.: 11/735,037

(22) Filed: Apr. 13, 2007

(51) Int. Cl. A01K 97/12; A01K 87/00

(52) U.S. Cl. 43/17; 43/17.5; 43/18.1 R

(57) ABSTRACT

A fishing pole includes an elongate pole having opposed first and second ends, a top fisherman-facing side, a bottom water-facing side, a handle formed in the first end, and a tip top formed in the second end. A strike indicator light source is mounted to the fishing pole proximate to the tip top, and a broad illumination light source is mounted to the fishing pole proximate to the handle. A switch is mounted to the fishing pole proximate to the handle is operatively coupled to the strike indicator light source and the broad illumination light source and is movable into a first position activating the strike indicator light source, and a second position activating the broad illumination light source.

### FIELD OF THE INVENTION

The present invention relates to fishing poles.

### BACKGROUND OF THE INVENTION

Fishing is the sport of catching fish. Among sportsman fishing is principally carried out with the use of lure attached to a fishing line cast by the use of a long, flexible fishing rod, and a reel about which the fishing line is wound. The fishing line is cast by the rod, which, in turn, propels the lure. The lure wielded by the fishing line influenced by the fisherman in the use of the fishing pole is furnished with a hook. A strike occurs when a fish takes the lure into its mouth for consumption. When a strike to the lure occurs, action on the lure by the fish acts on the fishing line which, in turn, acts on the fishing rod causing the tip of the rod to tremble. At the moment of a strike, an attentive fisherman visualizing the trembling in the tip of the fishing rod coupled with an associated pulling force applied to the fishing rod will normally pull the rod upwardly in a quick, brief stroke in order to set the hook into the fish's mouth, at which point the fish is then reeled in by the fisherman by reeling in the fishing line with the fishing reel.

Although daytime fishing is preferred among most fisherman, fishing during periods of low ambient sunlight, such as in the early morning and the late evening, often prove particularly productive. The difficulty with fishing in dark and low light conditions rests principally with the inability for the fisherman to see the tip of his fishing pole and the difficulty in seeing fish when caught and removing lures from the mouths of caught fish. Accordingly, what is needed is a fishing pole with lighting features which allow a fisherman to easily visualize the tip of his fishing pole in dark and low light conditions, and that also provides broad illumination in the vicinity of the fishing pole for illuminating areas in and around the fishing pole where fish are reeled in thereby aiding a fisherman in easily seeing caught fish and removing lures from the mouths of caught fish.

### SUMMARY OF THE INVENTION

In a fishing pole including an elongate pole having opposed first and second ends, a top fisherman-facing side, a bottom water-facing side, a handle formed in the first end, and a tip top formed in the second end, improvements therein according to the principle of the invention include a strike indicator light source mounted to the fishing pole proximate to the tip top, and a broad illumination light source mounted to the fishing pole proximate to the handle. A shield is mounted to the fishing pole proximate to the broad illumination light source for focusing broad illumination light generated by the broad illumination light source away from the bottom water-facing side and shielding the broad illumination light source from view in a direction facing the top fisherman-facing side of the fishing pole. A switch, mounted to the fishing pole and operatively coupled to the strike indicator light source and the broad illumination light source, is movable into a first position activating the strike indicator light source, and a second position activating the broad illumination light source. A reel seat is formed in the fishing pole adjacent to the handle, and the broad illumination light is preferably mounted to the fishing pole proximate to the handle between the tip top and the reel seat. A power source is carried by the fishing pole for providing electrical power to the switch, the indicator light source, and the broad illumination light source. Preferably, the power source is carried by the handle, and is a battery power source. The switch is formed in the fishing pole proximate to the handle, and, in a further and preferred embodiment, is formed in the handle. Preferably, the strike indicator light source is mounted to the top fisherman-facing side of the fishing pole proximate to the tip top.

In a fishing pole including a butt section having opposed proximal and distal ends, a top fisherman-facing side, a bottom water-facing side, a handle formed in the proximal end of the butt section, and an engagement ferrule formed in the distal end of the butt section, and a tip section having opposed proximal and distal ends, a top fisherman-facing side, a bottom water-facing side, a complemental engagement ferrule formed in the proximal end of the tip section, and a tip top formed in the distal end of the tip section, improvements therein according to the principle of the invention include a broad illumination light source mounted to the butt section proximate to the handle, and a shield mounted to the butt section proximate to the broad illumination light source for focusing broad illumination light generated by the broad illumination light source away from the bottom water-facing side of the butt section and shielding the broad illumination light source from view in a direction facing the top fisherman-facing side of the butt section. A switch is mounted to the butt section. A first electrical contact is formed in the engagement ferrule formed in the distal end of the butt section, and is electrically connected to the switch. A strike indicator light source is mounted to the tip section proximate to the tip top. A second electrical contact is formed in the complemental engagement ferrule formed in the proximal end of the tip section, and is electrically connected to the strike indicator light source. The first electrical contact is coupled to the second electrical contact in response to engagement of the engagement ferrule formed in the distal end of the butt section to the complemental engagement ferrule formed in the proximal end of the tip section electrically and operatively coupling the indicator light source to the switch. With the engagement ferrule engaged to the complemental engagement ferrule coupling the first electrical contact to the second electrical contact, the switch is movable into a first position activating the strike indicator light source, and a second position activating the broad illumination light source. A reel seat is formed in the butt section adjacent to the handle, and the broad illumination light is mounted to the butt section proximate to the handle between the distal end of the butt section and the reel seat. A power source carried by the butt section provides electrical power to the switch, the indicator light source, and the broad illumination light source. Preferably, the power source is carried by the handle, and consists of a battery power source. The switch is formed in the butt section proximate to the handle, and is preferably formed in the handle. The strike indicator light source is mounted to the top fisherman-facing side of the tip section proximate to the tip top.

Consistent with the foregoing summary of preferred embodiments, and the ensuing detailed description, which are to be taken together, the invention also contemplates associated apparatus and method embodiments.

### BRIEF DESCRIPTION OF THE DRAWINGS

Referring to the drawings:

FIG. 1 is a perspective view of a fishing pole constructed and arranged in accordance with the principle of the invention shown as it would appear in use, the fishing pole including a butt section including a handle incorporating a broad illumination light source for providing broad illumination in the vicinity of the handle, a blade section including a tip incorporating a strike indicator light source, and a switch operative for independently activating the broad illumination light source and the strike indicator light source;

FIG. 2 is a side elevational view of the fishing pole of FIG. 1;

FIG. 3 is a fragmented, partially exploded perspective view of the butt section of the fishing pole of FIG. 1 illustrating the handle of the fishing pole, a receptacle formed in the handle for receiving batteries, and a cap engagable to the handle for closing the receptacle formed in the handle;

FIG. 4 is a fragmented top plan view of the butt section of the fishing pole of FIG. 1;

FIG. 5 is an electrical schematic representation of the fishing pole of FIG. 1 illustrating batteries electrically connected to a switch that is in turn electrically connected the broad illumination light source and the strike indicator light source;

FIG. 6 is a fragmented perspective view of the fishing pole illustrating a light source incorporated therewith shown partially exploded and in partial cross section;

FIG. 7 is an enlarged, fragmented side elevational view of the handle of the butt section of the fishing pole of FIG. 1 illustrating the switch as it would appear in an OFF position;

FIG. 8 is an enlarged, fragmented top plan view of the handle of the butt section of the fishing pole of FIG. 1 illustrating the switch as it would appear in an OFF position;

FIG. 9 is an enlarged fragmented perspective view of the tip of the blade section of the fishing pole of FIG. 1 illustrating the strike indicator light source including a light receptacle adapted to operatively receive a light bulb;

FIG. 10 is an enlarged, fragmented perspective view of a connecting joint between the butt section and the tip section of the fishing pole of FIG. 1 including a male engagement element formed in the butt section shown as it would appear detached from a corresponding female engagement element formed in the tip section;

FIG. 11 is a sectional view taken along line 11-11 of FIG. 10;

FIG. 12 is a sectional view taken along line 12-12 of FIG. 10; and

FIG. 13 is a sectional view taken along line 13-13 of FIG. 10.

### DETAILED DESCRIPTION OF PREFERRED EMBODIMENTS

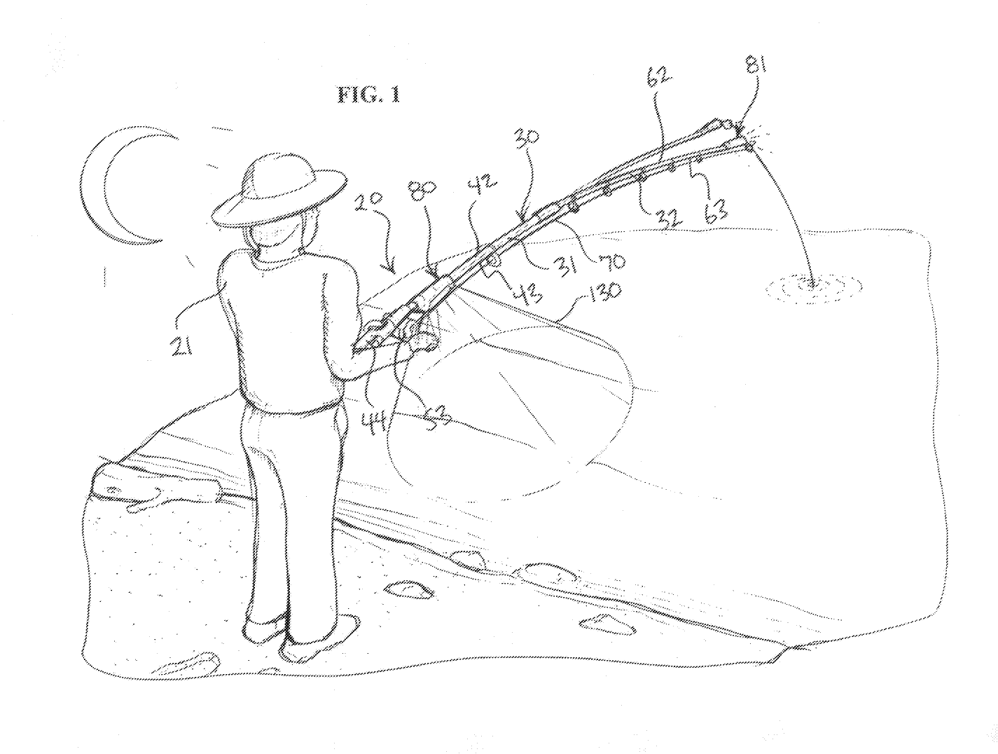

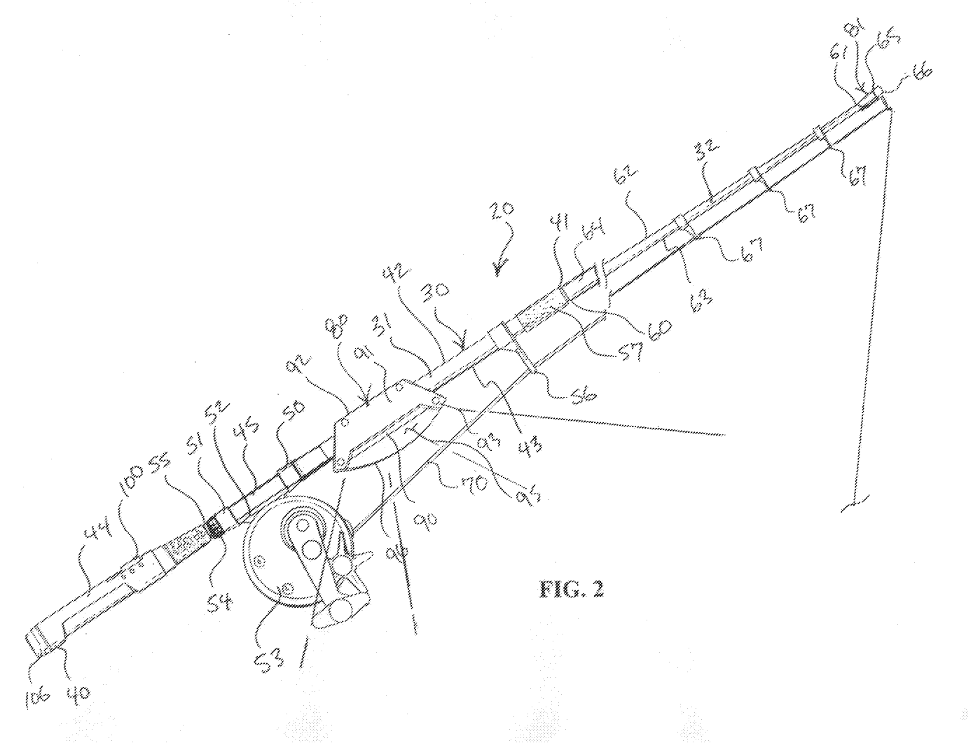

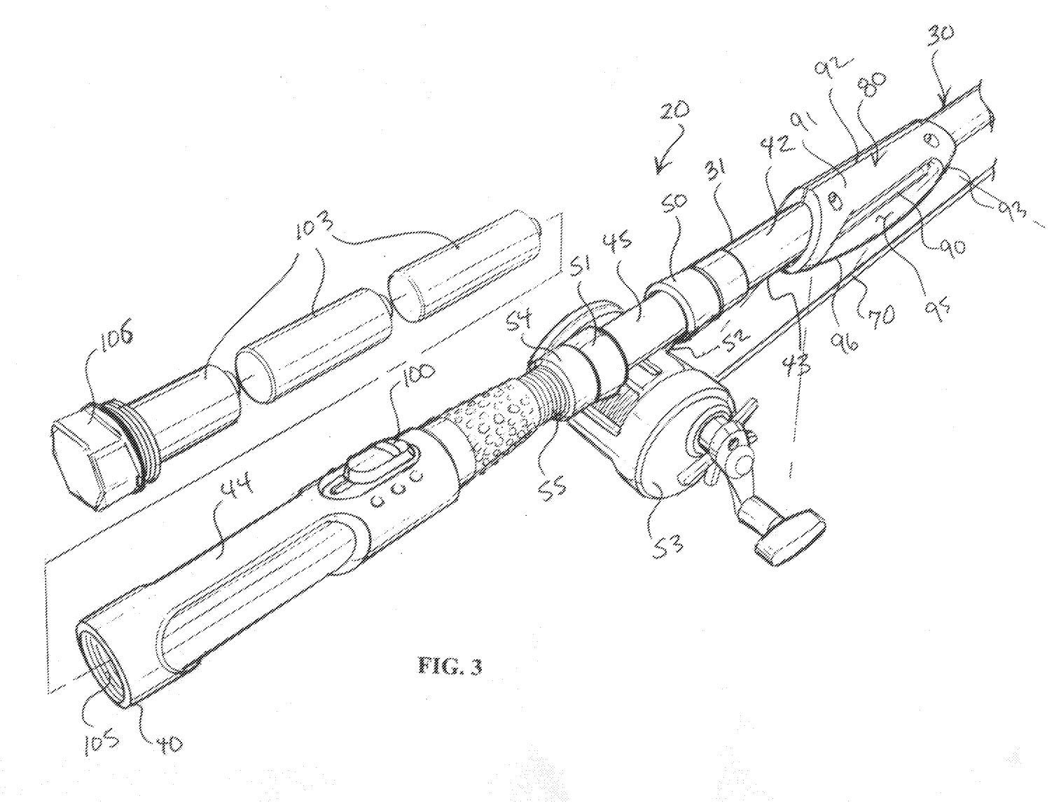

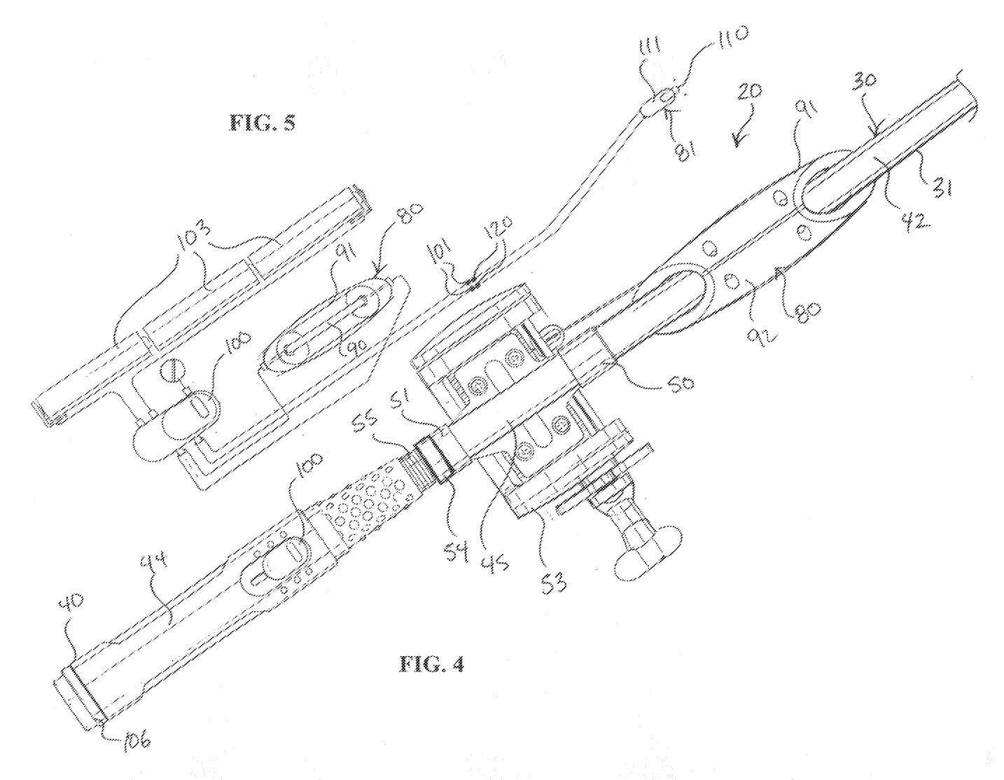

Turning now to the drawings, in which like reference characters indicate corresponding elements throughout the several views, attention is first directed to FIG. 1 in which there is seen a perspective view of a fishing pole 20 constructed and arranged in accordance with the principle of the invention shown as it would appear in use by a fisherman 21 engaged in the act of fishing. Looking to FIG. 2, fishing pole 20 includes an elongate pole 30 consisting principally of a butt section 31 and a tip section 32. Butt section 31 is elongate and has opposed proximal and distal ends 40 and 41, a top fisherman-facing side 42, and a bottom water-facing side 43. Referring also to FIGS. 3, 4, and 6, a handle 44 is formed in proximal end 40. A reel seat 45 is also formed in proximal end 40 of butt section 31, and in this embodiment is located forwardly of handle 44 between handle 44 and distal end 41 of butt section 31. A hood 50 and an opposed reel seat ring 51 encircle reel seat 45 and are associated with reel seat 45, and are used to secure a pole mount 52 of a fishing reel 53 in a conventional and well-known manner. A threaded lock ring 54 is disposed rearwardly of reel seat 51, and encircles and is threaded onto a threaded portion 55 formed in proximal end 40 of butt section 31 between reel seat 45 and handle 44. After capturing pole mount 52 between hood 50 and reel seat ring 51, lock ring 54 may be tightened against seat ring 51 to shorten the distance between reel seat ring 51 and hood 50 to capture and secure pole mount 52 between reel seat ring 51 and hood 50. As best seen in FIG. 2, butt section 31 supports a butt guide 56 disposed adjacent to distal end 41, which is, in turn, formed with an engagement ferrule 57. Butt guide 56 projects downwardly away from bottom water-facing side 43 of butt section 31.

Referencing FIG. 2, tip section 32 is elongate and has opposed proximal and distal ends 60 and 61, a top fisherman-facing side 63, and a bottom water-facing side 64. Proximal end 60 of tip section 32 is formed with an engagement ferrule 65, and distal end 61 of tip section 32 is formed with a tip top 65 that is, in turn, formed with a top or end ring 66. Tip section 32 is furnished with a plurality of spaced-apart, graduated guides 67 between proximal and distal ends 60 and 61. Guides 67 project downwardly away from bottom water-facing side 63 of tip section 32.

In the present embodiment, engagement ferrule 57 formed in distal end 41 of butt section 31 is a female engagement ferrule, and engagement ferrule 64 formed in proximal end 60 of tip section 32 is a male engagement ferrule. Ferrules 57 and 64 are used to attach distal end 41 of butt section 31 to proximal end 60 of tip section 32 to form pole 30 as illustrated in FIGS. 1 and 2. To attach tip section 32 to butt section 31, male engagement ferrule 64 is forcibly inserted into female engagement ferrule 57 making sure that top side of butt section 31 is aligned with top side 62 of tip section 32, and that bottom side 43 of butt section 31 aligns with bottom side 63 of tip section 32 thereby aligning butt guide 56 of butt section 31 and guides 67 of tip section 32 along the bottom, water-facing sides 43 and 63 of butt and tip sections 31 and 32 forming pole 30.

After engaging tip section 32 to butt section 31 in the foregoing manner, sides 42 and 62 cooperate forming the top, fisherman-facing side of fishing pole 20, and sides 43 and 63 cooperate forming the bottom, water-facing side of fishing pole 20. After forming pole 30, fishing reel 53 is mounted to reel seat 45 by securing pole mount 52 to reel seat 45 with hood 50 and reel seat ring 51. Fishing reel 53 projects downwardly and away from bottom, water-facing side 43 of butt section 31. Fishing line 70 maintained by fishing reel 53 may then be taken up and threaded first through butt guide 56 and then sequentially through guides 67 of tip section and finally through end ring 66 formed in tip top 65. At this point, a lure may be attached to the end of fishing line 70 in preparation for fishing in the normal manner, whereby handle 44 is taken up by hand by the fisherman and is used to wield fishing pole 20 in the act of managing and casting fishing line 70 for the purpose of managing and casting the fishing lure attached to fishing line 70.

In the recommended and intended use of fishing pole 20 as generally illustrated in FIG. 1, handle 44 is taken up and gripped by hand and fishing rod 20 is held such that the top, fisherman-facing side of fishing pole 20 faces upwardly toward the face of the fisherman wielding fishing pole 20, and the bottom, water-facing side of fishing pole 20 faces downwardly toward the water to be fished. By holding fishing pole 20 in this recommended and intended manner, the fisherman may then wield fishing pole 20 and engage in the act of fishing in the normal manner. To take down fishing pole 20 upon completion of fishing, the foregoing operation for assembling fishing pole 20 is simply reversed. The ferrules or joints of a quality fishing pole always fit snuggly, and often so tightly that it is difficult to separate them. Before joining ferrules 57 and 64, it is recommended that male engagement ferrule 64 be lubricated for facilitating easy disassembly.

Set forth for the purpose of reference in connection with the ensuing detailed description of the preferred embodiment of the present invention, the foregoing brief description of fishing pole 20 is intended to be generally representative of a typical fishing pole. Details not specifically illustrated and described will be readily understood and appreciated by those skilled in the art. It is to be understood that although reel seat 45 is formed forwardly of handle 44, reel seat 45 may be formed in proximal end 40 of butt section 31 rearwardly of handle 44, if desired, which is actually an arrangement common among fishing poles designed to be used for fly fishing.

Referencing FIGS. 1 and 2, fishing pole 20 is furnished with a broad illumination light fixture 80 mounted to butt section 31 proximate to handle 44, and a strike indicator light fixture 81 mounted to tip section 32 proximate to tip top 65, according to the principle of the invention. Referring to FIGS. 2, 3, and 6, broad illumination light fixture 80 consists of a light bulb 90 attached to a light base 91 that is, in turn, affixed to butt section 31 at a location somewhat forward of reel seat 45 between reel seat 45 and distal end 41 (FIG. 2) of butt section 31. Light base 91 includes an upper end 92 that embraces and encircles butt section 31 and which is secured in place with adhesive, screws, rivets, or the like, and an opposed lower end 93 projecting downwardly away from bottom, water-facing side 43 of butt section 31. Light base 91 may, if desired, be integrally formed with butt section 31. Light bulb 90 is mounted to light base 91, and is maintained in place between bottom, water-facing side 43 of butt section 31 and lower end 93 of light base 91. Light bulb 90 is located in a cavity 95 formed in lower end 93 of light base 91. A transparent lens or cover 96 is affixed to lower end 93 of light base 91 enclosing cavity 95 and light bulb 90 disposed therein. Preferably, a substantially water tight seal is formed between cover 96 and lower end 93 of light base 91.

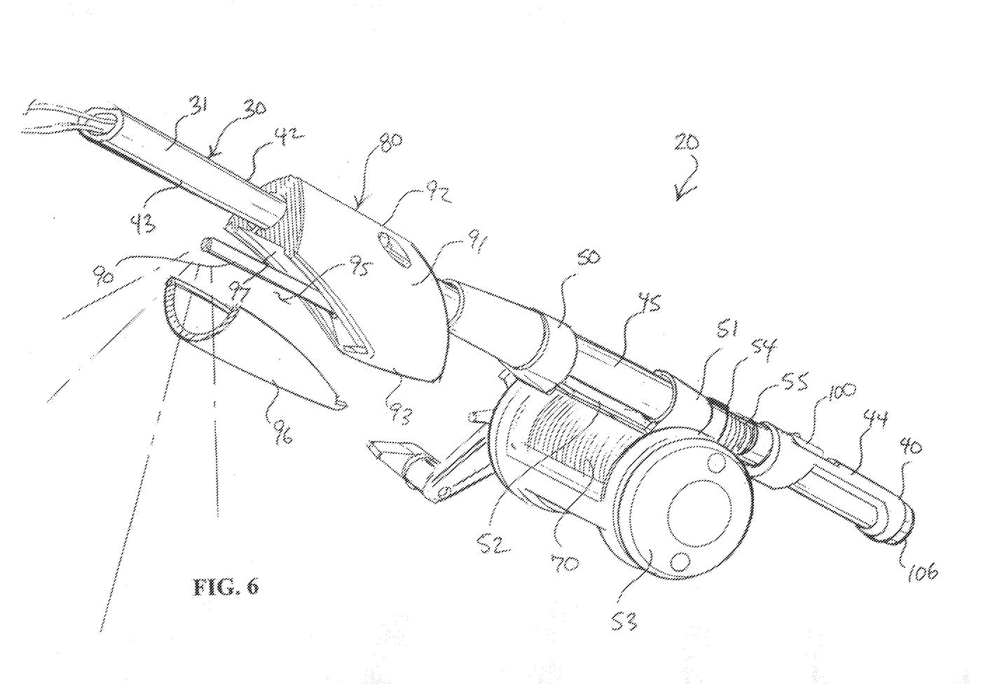

When activated and thereby illuminated, light bulb 90 provides broad illumination, which is directed outwardly from lower end 93 of light base 91 through cover 96. Looking to FIG. 6, light bulb 90 lies underneath an inner surface 97 formed by light base 91 proximate upper end 92, which acts as a shield that consolidates and focuses broad illumination light generated by light bulb 90 away from bottom, water-facing side 43 of butt section 31 through cover 96, and also shields light bulb 90 from view in a direction facing top, fisherman-facing side 42 of butt section 31 and prevents light generated by light bulb 90 from shining upwardly from top, fisherman-facing side 42 of butt section 31. Light bulb 90 is an elongate, relatively thin and tubular fluorescent light bulb in the present embodiment, although light-emitting diode, incandescent light bulb, or other selected light bulb form may be utilized. Also, although broad light fixture 80 incorporates one light bulb in the present embodiment, more may be utilized, if desired.

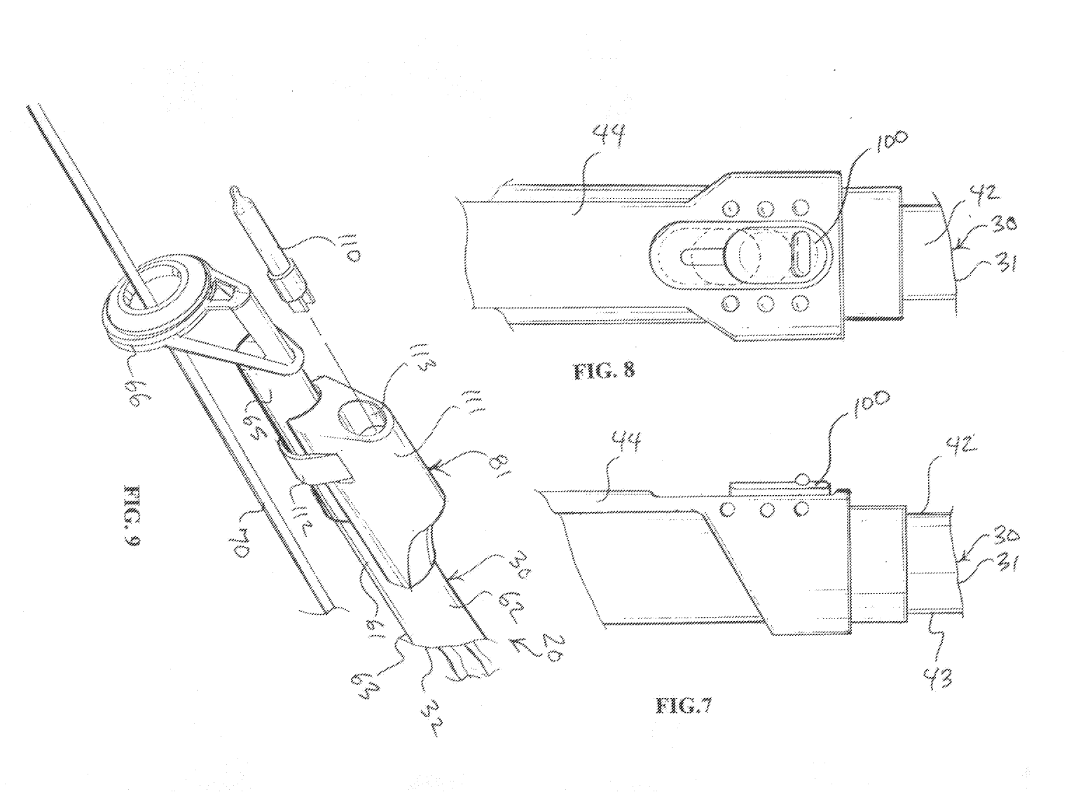

Referencing FIGS. 2, 3, and 6, a conventional electrical switch 100 is mounted to butt section 31, and is electrically connected to broad light fixture 80 and, in turn, to light bulb 90 conventionally with electrical wiring formed in butt section 31 and is used to turn light bulb 90 between ON and OFF positions. Preferably, the electrical wiring electrically connecting switch 100 to broad light fixture 80 is formed in the hollow interior of butt section 31. Switch 100 is preferably formed in handle 44 adjacent to reel seat 44 so as to be easily accessible by a user's hand holding handle 44, although switch 100 may be formed elsewhere along handle 44 or adjacent to handle 44 without departing from the invention. In the present embodiment, switch 100 is located along top, fisherman-facing side 42 of butt section 31 toward the forward end of handle 44 as illustrated in FIGS. 2-4, and 6-8. If desired, switch 100 may be located along bottom, water-facing side 43 of butt section 31 or other designated location without departing from the invention.

Referring now to FIGS. 10, 11, and 13, an electrical contact 101 is formed in engagement ferrule 57 formed in distal end 41 of butt section 31. Electrical contact 101 is electrically connected to switch 100 conventionally with electrical wiring formed in butt section 31. Preferably, the electrical wiring electrically connecting switch 100 to electrical contact 101 is formed in the hollow interior of butt section 31. Switch 100 is used to provide energizing power to electrical contact 101.

Electrical power is provided to switch 100 from a power source onboard butt section 31. The electrical wiring between switch 100 and light bulb 90 form a first circuit therebetween, and the electrical wiring between switch 100 and electrical contact 101 form a second circuit therebetween. Through the operation of switch 100, the first circuit between switch 100 and light bulb 90 is movable between an open position isolating the power source from light bulb 90 corresponding to the OFF position of light bulb 90, and a closed position providing electrical power from the power source to light bulb 90 corresponding to the ON position of light bulb 90 providing illumination. Through the operation of switch 100, the second circuit between switch 100 and electrical contact is movable between an open position isolating the power source from electrical contact 101 corresponding to the OFF position of electrical contact 101, and a closed position providing electrical power from the power source to electrical contact 101 corresponding to the ON position of electrical contact 101.

Referencing FIG. 3, the power source onboard butt section 31 consists of batteries 103, which are received in a battery receptacle 104 formed in handle 44. Batteries 103 are placed into battery receptacle 104 from an opening 105 formed in proximal end 40 of butt section 31, and a cap 106 is threadably secured to proximal end 40 of butt section 31 closing opening 105 electrically connecting batteries to switch 100 with the electrical wiring formed in butt section 31. In the present embodiment, three conventional AA alkaline batteries are utilized. However, those having ordinary skill in the art will readily appreciate that any suitable form of battery, including any desired or suitable number of batteries, may be provided and utilized for the power source onboard butt section 31.

Referencing FIG. 9, strike indicator light fixture 81 consists of a light bulb 110 and a light base 111 that is, in turn, affixed to tip top 65 just rearwardly of end ring 66 with a band 112 in the present embodiment, although adhesive, or one or more screws or rivets or the like can be used. Light base 111 may be integrally formed with distal end 61 of tip section 32, or with tip top 65, if desired. Light base 111 is formed with a light socket 113, which receives light bulb 110. Light bulb 110 and light socket 113 are exemplary of a conventional light bulb and light socket arrangement commonly utilized in connection with the lights forming the strings of lights used for decorative purposes, particularly the type of strings of lights used in decorating Christmas trees.

Light base 111 is located atop top, fisherman-facing side 62 of tip section 32 proximate distal end 61, and in turn supports light bulb 110 atop top, fisherman-facing side 62 of tip section 32 proximate distal end 61. When activated and thereby illuminated, light bulb 90 provides bright, local illumination at distal end 61 of tip section 32.

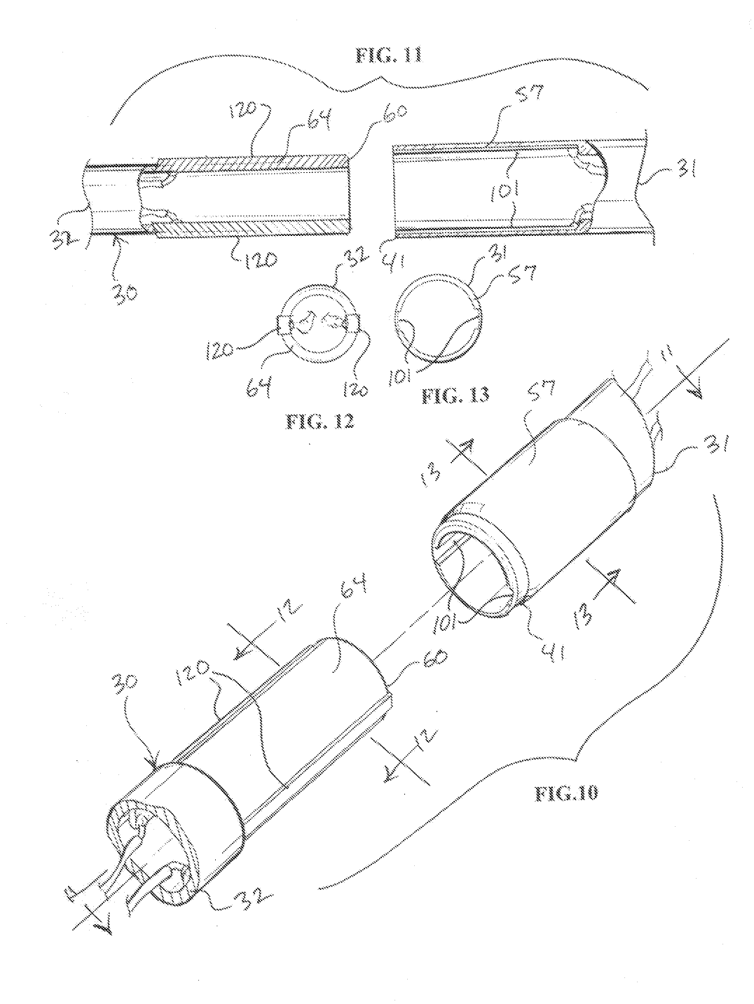

Referring now to FIGS. 10, 11, and 12, an electrical contact 120 is formed in engagement ferrule 64 formed in proximal end 60 of tip section 32. Electrical contact 120 is electrically connected to strike indicator light fixture 81 and, in turn, to light bulb 110 fitted into light socket 113, conventionally with electrical wiring formed in tip section 32. Preferably, the electrical wiring electrically connecting strike indicator light fixture 81 to electrical contact 120 is formed in the hollow interior of tip section 31.

Electrical contact 101 formed in female engagement ferrule 57 formed in distal end 41 of butt section 31 electrically contacts electrical contact 120 formed in male engagement ferrule 64 formed proximal end 60 of tip section 32, thereby electrically connecting strike indicator light fixture 81 to switch 100. In the present embodiment, electrical contact 101 consists of a pair of opposed inwardly-formed electrical contact grooves formed in female engagement ferrule 57, and electrical contact 120 consists of a corresponding pair of opposed outwardly-formed electrical contact tongues formed in male engagement ferrule 57. As previously mentioned, tip section 32 is attached to butt section 31 by forcibly inserting male engagement ferrule 64 into female engagement ferrule 57, whereby the electrical contact tongues forming electrical contact 120 are received by, and electrically connected to, the corresponding electrical contact grooves forming electrical contact 101. Those having ordinary skill in the art will readily appreciate that any suitable form of complementing electrical contact structure may be utilized between ferrules 57 and 64 for forming an electrical connection between strike indicator light fixture 81 and switch 100 in response to the attachment of ferrule 57 to ferrule 64. Furthermore, although ferrule 57 is a female ferrule and ferrule 64 is a male ferrule, this arrangement can be reversed, if desired. Still further, although ferrule 57 is formed with groove contacts and ferrule 64 is formed with corresponding tongue contacts, this arrangement can be reversed or mixed and matched as desired.

As previously mentioned, the electrical wiring between switch 100 and light bulb 90 form a first circuit therebetween, and the electrical wiring between switch 100 and electrical contact 101 form a second circuit therebetween. The second circuit is extended between strike indicator light fixture 81 and switch 100 in response to the engagement between ferrules 57 and 64 electrically connecting electrical contact 101 formed in ferrule 57 to electrical contact 120 formed in ferrule 64, in accordance with the principle of the invention.

FIG. 5 is a schematic representation of fishing pole 20 as it would appear with ferrule 57 formed in butt section 31 secured to ferrule 64 formed in tip section 32 securing tip section 32 to butt section 31 and electrically connecting electrical contact 120 formed in ferrule 64 of tip section 32 to electrical contact 101 formed in ferrule 54 of butt section 31 forming the second circuit between switch 100 and strike indicator light fixture 81. With fishing pole 20 so assembled, switch 100 may be moved between three positions. In the first of the three positions of switch 100, the circuit between switch 100 and broad illumination light fixture 80 is open corresponding to an OFF position of broad illumination light fixture 80, and the circuit between switch 100 and strike indicator light fixture 81 is open corresponding to an OFF position of strike indicator light fixture 81. In the second of the three positions of switch 100, the circuit between switch 100 and broad illumination light fixture 80 is open corresponding to the OFF position of broad illumination light fixture 80, and the circuit between switch 100 and strike indicator light fixture 81 is closed corresponding to an ON position of strike indicator light fixture 81 thereby energizing light bulb 110 providing localized illumination at distal end 61 of tip section 32. In the third of the three positions of switch 100, the circuit between switch 100 and broad illumination light fixture 80 is closed corresponding to an ON position of broad illumination light fixture 80 thereby energizing light bulb 90 providing broad illumination in the vicinity of handle 44, and the circuit between switch 100 and strike indicator light fixture 81 is open corresponding to the OFF position of strike indicator light fixture 81.

Fishing pole 20 is particularly useful in fishing during night or low light conditions. In the recommended and intended use of fishing pole 20 as generally illustrated in FIG. 1 as previously explained, handle 44 is taken up and gripped by hand and fishing rod 20 is held such that the top, fisherman-facing side of fishing pole 20 faces upwardly toward the face of the fisherman wielding fishing pole 20, and the bottom, water-facing side of fishing pole 20 faces downwardly toward the water to be fished. By holding fishing pole 20 in this recommended and intended manner, light bulb 110 maintained by light base 111 is disposed upwardly from the top, fisherman-facing side of fishing pole 20 at distal end 61 of tip section 32 being thereby easily seen by the fisherman wielding fishing pole 20, and light bulb 90 maintained by light base 91 of broad illumination light fixture 80 is disposed downwardly away from the bottom, water-facing side of fishing pole 20 underneath inner surface 97 formed by light base 91 proximate upper end 92 as shown in FIG. 6 shielding light bulb 90 from view by the fisherman in a direction facing the top, fisherman-facing side 42 of fishing pole 20 preventing light and glare from flashing up into the fisherman's eyes which may otherwise impair the fisherman's vision during night and low-light conditions.

In operation during night and low-light conditions, fishing pole 20 is taken up for use as previously explained and switch 100 is moved from its first position corresponding to the OFF positions of light fixtures 80 and 81 to its second position activating strike indicator light fixture 81 providing localized illumination by light bulb 110 at distal end 61 of tip section 32 of fishing pole 20. Because in night and low-light conditions it may difficult for the fisherman to see distal end 61 of tip section 32, the localized illumination at distal end 61 of tip section 32 allows the fisherman to easily visualize action applied to distal end 61 of tip section 32 caused by a fish striking the lure attached to fishing line 70, in which instance the fisherman may wield fishing pole 20 to set the lure into the fish's mouth in the normal manner. Upon setting the lure into the fish's mouth, the fisherman may then use reel 53 to reel in fishing line 70 and, thus, reel in fish.

Because it may also be difficult for the fisherman to see the fish after it is reeled in and to easily see the lure to remove it from the fish's mouth, after the lure is set into the fishes mouth the fisherman may move switch 100 from the second position to the third position activating broad illumination light fixture 80 providing broad illumination from light bulb 90 in the vicinity of handle 44. Because light bulb 90 is disposed downwardly away from the bottom, water-facing side of fishing pole 20 underneath inner surface 97 formed by light base 91 proximate upper end 92 as shown in FIG. 6, inner surface 97 of light base 91 shields light bulb 90 from view by the fisherman in a direction facing the top, fisherman-facing side 42 of fishing pole 20 preventing light and glare generated by light bulb 80 from flashing up into the fisherman's eyes which may otherwise impair the fisherman's vision, and consolidates and focuses or otherwise directs a broad and yet focused beam 130 (FIG. 1) of light downwardly away from the bottom, water-facing side of fishing pole 20 from the vicinity of handle 44 toward the water being fished thereby illuminating the water being fished in front of the fisherman as shown in FIG. 1 and the caught fish as it is reeled in allowing the fisherman to net or take up the fish by hand and remove the lure from the fish's mouth, in accordance with the principle of the invention. After the fish is either released or kept by the fisherman, switch 100 may be moved back into its second position for further fishing according to the teachings provided herein, or into its first position upon the completion of fishing.

The invention has been described above with reference to a preferred embodiment. However, those skilled in the art will recognize that changes and modifications may be made to the embodiment without departing from the nature and scope of the invention. Various changes and modifications to the embodiment herein chosen for purposes of illustration will readily occur to those skilled in the art. To the extent that such modifications and variations do not depart from the spirit of the invention, they are intended to be included within the scope thereof.

Having fully described the invention in such clear and concise terms as to enable those skilled in the art to understand and practice the same, the invention claimed is:

1. In a fishing pole including an elongate pole having opposed first and second ends, a top fisherman-facing side, a bottom water-facing side, a handle formed in the first end, and a tip top formed in the second end, improvements therein comprising:
a strike indicator light source mounted to the fishing pole proximate to the tip top;
a broad illumination light source mounted to the fishing pole proximate to the handle;
a shield mounted to the fishing pole proximate to the broad illumination light source for focusing broad illumination light generated by the broad illumination light source away from the bottom water-facing side and shielding the broad illumination light source from view in a direction facing the top fisherman-facing side of the fishing pole; and
a switch mounted to the fishing pole operatively coupled to the strike indicator light source and the broad illumination light source, the switch movable into a first position activating the strike indicator light source, and a second position activating the broad illumination light source.

2. The improvements according to claim 1, further comprising:
a reel seat formed in the fishing pole adjacent to the handle; and
the broad illumination light mounted to the fishing pole proximate to the handle between the tip top and the reel seat.

3. The improvements according to claim 1, further comprising:
a reel seat formed in the fishing pole between the handle and the tip top; and
the broad illumination light source mounted to the fishing pole between the tip top and the reel seat.

4. The improvements according to claim 1, further comprising a power source carried by the fishing pole for providing electrical power to the switch, the indicator light source, and the broad illumination light source.

5. The improvements according to claim 4, wherein the power source is carried by the handle.

6. The improvements according to claim 5, wherein the power source comprises a battery power source.

7. The improvements according to claim 1, wherein the switch is formed in the fishing pole proximate to the handle.

8. The improvements according to claim 1, wherein the switch is formed in the handle of the fishing pole.

9. The improvements according to claim 1, wherein the strike indicator light source is mounted to the top fisherman-facing side of the fishing pole proximate to the tip top.

10. In a fishing pole including:
a butt section having opposed proximal and distal ends, a top fisherman-facing side, a bottom water-facing side, a handle formed in the proximal end of the butt section, and an engagement ferrule formed in the distal end of the butt section; and
a tip section having opposed proximal and distal ends, a top fisherman-facing side, a bottom water-facing side, a complemental engagement ferrule formed in the proximal end of the tip section, and a tip top formed in the distal end of the tip section;
improvements therein comprising:
a broad illumination light source mounted to the butt section proximate to the handle;
a shield mounted to the butt section proximate to the broad illumination light source for focusing broad illumination light generated by the broad illumination light source away from the bottom water-facing side of the butt section and shielding the broad illumination light source from view in a direction facing the top fisherman-facing side of the butt section;
a switch mounted to the butt section;
a first electrical contact formed in the engagement ferrule formed in the distal end of the butt section electrically connected to the switch;
a strike indicator light source mounted to the tip section proximate to the tip top;
a second electrical contact formed in the complemental engagement ferrule formed in the proximal end of the tip section electrically connected to the strike indicator light source;
the first electrical contact coupled to the second electrical contact in response to engagement of the engagement ferrule formed in the distal end of the butt section to the complemental engagement ferrule formed in the proximal end of the tip section electrically connecting the indicator light source to the switch; and
with the engagement ferrule engaged to the complemental engagement ferrule coupling the first electrical contact to the second electrical contact, the switch movable into a first position activating the strike indicator light source, and a second position activating the broad illumination light source.

11. The improvements according to claim 1, further comprising:
a reel seat formed in the butt section adjacent to the handle; and
the broad illumination light mounted to the butt section proximate to the handle between the distal end of the butt section and the reel seat.

12. The improvements according to claim 10, further comprising:
a reel seat formed in the butt section between the handle and the distal end of the butt section; and
the broad illumination light source mounted to the butt section between the distal end of the butt section and the reel seat.

13. The improvements according to claim 10, further comprising a power source carried by the butt section for providing electrical power to the switch, the indicator light source, and the broad illumination light source.

14. The improvements according to claim 13, wherein the power source is carried by the handle.

15. The improvements according to claim 14, wherein the power source comprises a battery power source.

16. The improvements according to claim 10, wherein the switch is formed in the butt section proximate to the handle.

17. The improvements according to claim 10, wherein the switch is formed in the handle of the butt section.

18. The improvements according to claim 10, wherein the strike indicator light source is mounted to the top fisherman-facing side of the tip section proximate to the tip top.
